(19) United States
(12) Patent Application Publication
(10) Pub. No.: US 2026/0332417 A1
(43) Pub. Date: Oct. 22, 2026

(54) Ecoh-Ledger - Parameter-Free, Tamper-Evident, Immutable Registry of the Recognition- Physics Cohesion Quantum E_coh

(71) Applicant: Jonathan Washburn, Austin, TX (US)

(72) Inventor: Jonathan Washburn, Austin, TX (US)

(21) Appl. No.: 19/652,395

(22) Filed: Apr. 20, 2026

Related U.S. Application Data
(60) Provisional application No. 63/792,725, filed on Apr. 22, 2025.

(51) Int. Cl. H04L 9/32

(52) U.S. Cl. CPC H04L 9/3218; H04L 9/3247

(57) ABSTRACT

An Ecoh-Ledger system and method are disclosed for constructing, signing, publishing, registering, retrieving, versioning, and verifying a machine-readable constant record in a tamper-evident, append-only, and independently auditable framework. A canonical bundle is deterministically generated, hashed, digitally signed, and published to content-addressable storage to obtain a content identifier. A publication record associated with the content identifier is inserted into an append-only transparency log, and proof material is generated for later verification. Verification includes retrieving the published content, recomputing a digest, verifying the signature, verifying inclusion in a committed log state, determining anchor sufficiency, and distinguishing a display-only refinement from a semantic change by comparing a deterministic digest for an exact-value field with a deterministic digest for display-layer information. Preferred embodiments maintain an immutable registry for the Recognition-Physics cohesion quantum E_coh.

### CROSS-REFERENCE TO RELATED APPLICATIONS

This application claims the benefit of U.S. Provisional Patent Application No. 63/792,725, filed on Apr. 22, 2025, the entirety of which provisional application is incorporated herein by reference to the extent permitted, provided that no essential material is incorporated by reference for purposes of satisfying 35 U.S.C. 112(a).

### BACKGROUND OF THE INVENTION

The present invention relates generally to distributed data provenance, cryptographic attestation, content-addressable publication, transparency logging, and verification infrastructure for scientific and technical constants, parameter sets, and related calibration records. More particularly, the present invention relates to systems and methods for constructing, signing, publishing, registering, versioning, retrieving, and verifying a machine-readable constant record in a tamper-evident, append-only, and independently auditable framework. In particularly preferred embodiments, the invention is directed to an immutable registry for the Recognition-Physics cohesion quantum E_coh, including an exact Recognition-Physics-native representation of the constant, one or more calibrated display representations of the constant, and associated provenance, derivation, version, and verification metadata.

In many technical, scientific, industrial, and regulatory settings, a constant or parameter used in simulation, calibration, device configuration, software execution, data processing, or analytical modeling must be not only numerically available, but also authoritative, traceable, reproducible, and independently verifiable. A laboratory, developer, manufacturer, regulator, auditor, or downstream user may need to determine whether a retrieved constant value is authentic, whether the value has been altered or superseded, whether the value is tied to a particular derivation or calibration basis, whether the value can be traced to a specific publication event, whether the value being used today is identical to the value used in a prior experiment or device configuration, and whether the full provenance chain can be validated without reliance on a single trusted intermediary. Conventional dissemination channels, including papers, websites, emails, source code comments, spreadsheets, static databases, file attachments, and informal internal copies, do not reliably provide these properties.

Existing approaches to publication of constants and technical parameters suffer from several technical shortcomings. A conventional paper may describe a value but typically does not provide a machine-verifiable authenticity layer cryptographically binding the value to a canonical data object. A website or database entry may present a value, but a downstream user often cannot determine whether the displayed record has been silently edited, replaced, rounded differently, copied incorrectly, mirrored inconsistently, or detached from the derivation and version information on which the record depends. A downloadable file may be copied among multiple repositories, but absent a robust provenance architecture, there may be no append-only audit trail showing when the file was first published, whether a later file superseded it, whether the later file changed the underlying exact value or merely updated a display representation, whether the file can be independently verified offline, or whether the current copy is bitwise identical to the originally published record. Conventional storage systems also tend to rely on location-based retrieval rather than content-based retrieval, thereby introducing additional uncertainty when mirrored, migrated, renamed, cached, or republished content is encountered. These shortcomings become more acute in contexts in which a constant is intended to function as an authoritative technical dependency across multiple systems. For example, a constant may be embedded in software source code, used in a scientific simulation, included in a hardware calibration workflow, referenced in a regulatory submission, stored in a manufacturing certificate, or propagated into a continuous integration or continuous deployment pipeline. In such cases, an unverified or drifted constant can affect not merely a publication, but an entire computational or physical workflow. Even where the numerical difference is small, the inability to prove provenance, integrity, version lineage, and publication history can materially impair reproducibility, quality assurance, regulatory traceability, audit readiness, and trust in the resulting technical output.

The need for a more robust infrastructure is especially evident for constants that are not merely empirical lookup values drawn from a preexisting standards table, but instead are disclosed, derived, curated, versioned, or maintained within a particular technical framework. In such circumstances, users often require both an exact semantic representation of the constant and a separately tracked display representation of that constant in one or more units, precisions, or calibration conventions. Conventional publication channels do not cleanly distinguish between an invariant exact-value representation and a calibrated or rounded display-value representation.

As a result, later refinements in precision, formatting, unit conversion, or external anchor metadata may be confused with substantive changes to the underlying constant itself. This makes it difficult to preserve historical continuity while also permitting orderly updates.

In the particular context of the present disclosure, the Recognition-Physics cohesion quantum E_coh is an important example of a constant requiring authoritative registration and verification. The exact Recognition-Physics-native representation of the cohesion quantum is given by E_coh=phi\hat{ }(−5). In various implementations, that exact-value representation may be accompanied by one or more calibrated display representations, including display values expressed in electronvolts, joules, frequencies, thermal units, or other representations suitable for engineering, publication, simulation, or regulatory use. The exact-value representation and the display-value representation serve different technical purposes and therefore benefit from being recorded separately but cryptographically bound within a common provenance framework. The exact-value representation is advantageously preserved as an invariant semantic expression, while one or more display-value fields may be updated in later versions of a record to reflect increased precision, changed formatting, revised unit presentation, revised calibration policy metadata, revised anchor-version metadata, or other presentation-related refinements without requiring deletion or silent overwrite of earlier records.

At present, there is no conventional mechanism that fully addresses these needs in an integrated manner. A static publication may disclose a value, but ordinarily does not provide deterministic canonicalization, content-addressable retrieval, cryptographic signing, append-only transparency logging, public inclusion proofs, consistency proofs, periodic public anchoring, online verification, offline verification, batch verification, structured supersedence, or a machine-readable distinction between exact and display forms of a constant. Even where one or more of these capabilities exists in isolation, conventional systems generally do not combine them into a unified architecture directed to scientific or technical constant records. For example, storage alone does not guarantee authenticity; signatures alone do not guarantee public append-only history; a hash alone does not provide version lineage; a database record alone does not provide content-addressable retrieval; and a publication timestamp alone does not prove that a later registry state is an append-only extension of an earlier state.

Transparency log architectures have demonstrated that append-only Merkle-based structures can provide strong public accountability in other technical environments. Similar architectural principles are relevant here because they permit a registry operator to publish a compact cryptographic commitment representing a large set of records, while allowing third parties to verify that a particular record is included in the committed set and that a newer version of the log is a proper append-only extension of an earlier version. When combined with digital signatures, secure key management, content-addressable publication, and independent anchor publication to one or more public ledgers, such structures can materially improve confidence that a scientific constant record has not been altered, deleted, rewritten, or silently replaced.

There therefore exists a need for a robust technical framework capable of constructing a canonical machine-readable constant record, deterministically serializing that record, cryptographically hashing and signing the resulting data, publishing the record or a signed package thereof to content-addressable storage, recording publication metadata in an append-only transparency log, periodically anchoring the state of that transparency log to one or more public blockchains or other immutable public timestamping systems, and exposing verification functionality by which a user, machine, auditor, device, regulator, or software pipeline can determine whether a given constant record is valid, authentic, included in the append-only history, and consistent with a trusted anchor state.

There is a further need for such a framework to support online verification, offline verification, batch verification, key rotation, geographically distributed signing infrastructure, version-preserving supersedence, multi-constant registry embodiments, threshold or federated signing embodiments, device-root-of-trust embodiments, CI/CD embodiments, regulatory and supply-chain embodiments, and related implementations in which the provenance of a constant is itself a critical technical dependency. There is additionally a need for such a framework to permit later refinement of display precision or calibration metadata while preserving earlier records as independently verifiable historical entries, thereby avoiding destructive overwrite and maintaining a complete append-only lineage.

Accordingly, a need remains for improved systems and methods for tamper-evident registration, publication, and verification of scientific and technical constant records, and particularly for improved systems and methods for maintaining an immutable, append-only, machine-verifiable registry of the Recognition-Physics cohesion quantum E_coh together with associated provenance, derivation, version, and verification data.

### SUMMARY OF THE INVENTION

The present invention provides systems and methods for constructing, signing, publishing, registering, retrieving, versioning, and verifying a machine-readable constant record in a tamper-evident, append-only, and independently auditable framework. In preferred embodiments, the invention is implemented as an Ecoh-Ledger system configured to maintain an immutable registry for the Recognition-Physics cohesion quantum E_coh, together with associated provenance, derivation, version, and verification data. The disclosed architecture is particularly well suited for scientific, computational, industrial, and regulatory contexts in which a constant or parameter must be not only numerically available, but also authoritative, cryptographically authenticated, content-addressable, historically traceable, and independently verifiable by users, devices, software systems, auditors, or regulators, and in which heterogeneous verifier implementations would otherwise be vulnerable to inconsistent serialization behavior, inconsistent current-record selection, inconsistent current-for-operational-use determinations, inconsistent stale or non-current classifications, inconsistent integrity and provenance policy results, and non-reproducible machine-actionable acceptance outcomes.

In one aspect, the invention provides a computer-implemented method in which a bundle builder constructs a canonical machine-readable bundle representing a constant record. The bundle preferably includes a constant identifier, an exact-value field, one or more display-value fields, optional uncertainty information, unit information, derivation metadata, framework metadata, timestamp information, schema-version information, and, where applicable, supersedence metadata linking a later record to an earlier record. The bundle is deterministically serialized such that the same input set produces the same canonical byte representation. This deterministic canonicalization is advantageous because it supports reproducible hashing, signing, retrieval, verification, and integrity and provenance policy results across distinct machines, repositories, and verification environments. In preferred embodiments, the deterministic canonicalization is performed under a schema-version-specific canonicalization profile and is used together with first and second deterministic digests over different canonicalized subsets of a record so as to reduce false verification failures attributable to serialization differences across independent implementations and to mechanically distinguish a display-only refinement from a semantic-change record.

In another aspect, the invention provides a cryptographic authenticity layer in which the canonical bundle, or a signed package containing the canonical bundle, is hashed using a cryptographic hash function and signed using a private key maintained in a secure hardware environment, such as a hardware security module. The resulting signature cryptographically binds the signed payload to an authorized publication event. In preferred embodiments, the signing key does not leave the secure hardware boundary, and the published record further includes metadata sufficient to identify the public verification key, key epoch, or key rotation state associated with the publication event. In this manner, the system provides a strong authenticity guarantee in addition to mere storage or publication.

In another aspect, the invention provides content-addressable publication of the canonical bundle, the signed bundle package, or both. In preferred embodiments, publication to a content-addressable storage system yields a content identifier that is derived from the content itself, such that any change to the content produces a corresponding change in the content identifier. This permits any retriever of the content identifier to verify that the retrieved object is the same object that was originally published, independent of the storage location from which the object is obtained. The system thereby reduces the risk associated with silent file replacement, mirrored copy drift, renamed files, or location-based ambiguity.

In another aspect, the invention provides an append-only transparency log configured to record publication data corresponding to the constant record. In preferred embodiments, the transparency log stores a publication record comprising at least a content identifier, a signature, and timestamp information, and optionally further stores a digest, an index, a key identifier, a supersedence pointer, or other metadata. The transparency log is preferably implemented as a Merkle-based append-only log so that a compact root value represents the state of many recorded entries. In such embodiments, the system can generate an inclusion proof showing that a given record is included within a committed log state, and can further generate a consistency proof showing that a later log state is a proper append-only extension of an earlier log state, wherein the inclusion proof and the consistency proof are generated from a deterministic log-entry encoding and authenticated-tree construction sufficient for independently implemented verifiers to reproduce the same proof-verification outcomes for the same publication records and log states. This append-only transparency architecture materially improves public accountability, auditability, and reproducible integrity and provenance policy results relative to conventional mutable registries.

In another aspect, the invention provides periodic anchoring of a transparency-log commitment to one or more public blockchains or other immutable public timestamping systems. In representative embodiments, the current Merkle root of the append-only transparency log is periodically committed to one or more public ledgers, thereby providing an external, independently verifiable timestamped witness to the state of the log at a given time. Even if an operator-controlled service later becomes unavailable, the external anchor record remains available as evidence of what log state existed at the time of anchoring. This feature further strengthens trust in the integrity and chronology of the constant record publication history and further permits independently implemented verifiers presented with the same anchor-state data and policy profile to reproduce the same anchor-sufficiency determination for operational use and the same integrity and provenance policy result.

In another aspect, the invention provides verification functionality by which a user, machine, software application, regulator, or auditor can determine whether a constant record is valid. In representative embodiments, a verification service receives a content identifier or related locator, retrieves the associated published object, recomputes the cryptographic digest, verifies the signature against an authorized public key, verifies an inclusion proof against a committed log root, verifies that the committed log root matches a trusted or independently confirmed anchor state, and applies one or more validity policies such as key-status validation, timestamp validation, version validation, freshness validation, supersedence validation, key-epoch validation, or validity-window validation. If the required conditions are satisfied, the system returns a validity determination indicating that the constant record is authentic and verifiable. If one or more conditions fail, the system may return an invalid or unknown result together with diagnostic information identifying the failed verification stage. Deterministic canonicalization and proof-based verification advantageously reduce false verification failures caused by serialization differences across heterogeneous implementations and thereby improve machine-to-machine interoperability, verification reproducibility, security-oriented acceptance decisions, computer security, and automated control-loop reliability by enforcing deterministic canonicalization of machine-readable constant records and reproducible machine-actionable gating outcomes under a deterministic resolver ordering. In preferred embodiments, the verification service further applies a deterministic resolver ordering and objective acceptance rules to produce the same machine-actionable acceptance or rejection result, the same stale, non-current, superseded-display, or semantic-change classification, the same current-for-operational-use determination, the same integrity and provenance policy result, and the same machine-actionable gating outcome across independent implementations presented with the same committed log state, proof material, public-key material, and policy profile.

In another aspect, the invention provides both online and offline verification modes. In online embodiments, a verification endpoint or API can retrieve current data and return a structured validity result. In offline embodiments, a verifier may operate using a locally cached or otherwise trusted log commitment, locally available public-key material, and a locally stored bundle or package without requiring real-time network access. This feature is advantageous in air-gapped facilities, manufacturing environments, embedded systems, secure research environments, and other deployments in which network isolation, limited bandwidth, or restricted connectivity makes live verification undesirable or impractical. In some embodiments, offline verification is performed within a bounded latency suitable for device boot paths, release gating, calibration gating, or other operational control loops, while preserving sufficient local proof material, public-key material, and policy metadata for independently implemented verifiers to reproduce the same inclusion-proof outcome, consistency-proof outcome, anchor-sufficiency determination, current-for-operational-use determination, the same acceptance or rejection result, the same integrity and provenance policy result, and the same machine-actionable gating outcome. The invention further contemplates batch verification of multiple content identifiers in a single workflow, thereby supporting continuous integration pipelines, fleet-scale device validation, supply-chain validation events, or multi-record audit procedures, with independently implemented batch verifiers reproducing the same per-record outcomes, failure-class attributions, aggregate status counts, and batch-summary determination when presented with the same content identifier set, proof material, public-key material, and policy profile.

In another aspect, the invention expressly distinguishes between an exact-value representation of a constant and one or more display-value representations of that constant. For the preferred E_coh embodiment, the exact Recognition-Physics-native representation is E_coh=phi\hat{ }(−5). A calibrated display representation may additionally be stored in electronvolts, joules, frequencies, thermal units, or other display forms suitable for engineering, simulation, publication, or regulatory use. The invention advantageously treats the exact-value field and the display-value field as distinct but cryptographically associated record components. This permits later refinement of display precision, formatting, unit conversion, calibration policy metadata, or anchor metadata without implying a substantive change to the underlying exact-value representation. In preferred embodiments, a later record may therefore supersede an earlier record while preserving the earlier record in the append-only history and while maintaining the exact-value field unchanged, such that a verifier or policy engine can classify the later record as a display-only refinement rather than a semantic change when the exact-value field remains unchanged.

In another aspect, the invention provides structured supersedence and version lineage. A later bundle or publication record may include metadata linking it to an earlier record that it supersedes, updates, refines, or replaces for designated purposes. The earlier record remains present in the append-only history and remains independently verifiable. This feature permits the system to preserve a complete historical lineage of constant records while also supporting current-version resolution, reproducible integrity and provenance policy results, and controlled transition from one published display representation or metadata state to another. In preferred embodiments, current-version resolution is performed under objective acceptance rules and a deterministic resolver ordering that evaluates supersedence status, validity-window satisfaction, anchor sufficiency, key authorization, and publication recency so that independent implementations presented with the same record set and policy profile reach the same current-record selection result and the same current-for-operational-use determination. Such functionality is particularly useful where a constant has an invariant semantic core but later receives improved presentation precision, revised metadata, revised key material, revised schema fields, or revised calibration descriptors.

In another aspect, the invention supports multi-constant registry embodiments, constant-set embodiments, federated publication embodiments, threshold-signature embodiments, hardware-root-of-trust embodiments, software build and CI/CD embodiments, device calibration embodiments, regulatory filing embodiments, and supply-chain embodiments. For example, a constant-set bundle may reference multiple individual constant bundles as a coordinated versioned set. A federated embodiment may require multiple institutions to co-sign or threshold-sign a publication record. A hardware-root-of-trust embodiment may require successful verification of a constant record at boot time before enabling a calibration or operational state. A CI/CD embodiment may require successful verification of a referenced constant record before a build, simulation, or deployment is permitted to proceed. A regulatory embodiment may package the content identifier, proof materials, and anchor information as part of a submission or audit file. These and other embodiments allow the provenance of a constant to function as a technical dependency within larger computational and physical systems, wherein deterministic canonicalization, dual-digest classification, and policy-qualified resolver behavior reduce false verification failures attributable to serialization variance, preserve exact-value semantics across display-layer refinements, and produce reproducible machine-actionable acceptance or rejection outcomes across independent implementations.

In preferred embodiments, the present invention is implemented with a canonical bundle builder, a hash-and-sign module, a secure signing device or hardware security module, a content-address publication module, an append-only transparency log, an anchor publication module, and an online and/or offline verification module. However, the invention is not limited to any particular software language, storage substrate, blockchain, hash function, signature scheme, hardware platform, deployment topology, or field set, except as expressly recited in the claims. The disclosed architecture may be implemented in centralized, distributed, federated, mirrored, partially offline, or hybrid forms.

Accordingly, the present invention provides a robust and technically improved framework for tamper-evident registration, publication, and verification of scientific and technical constant records, and particularly for maintaining an immutable, append-only, machine-verifiable registry of the Recognition-Physics cohesion quantum E_coh, while preserving exact-value semantics, display-value flexibility, public verifiability, version lineage, and audit-ready provenance, and while enabling independently implemented verifiers presented with the same published object, proof material, public-key material, anchor-state data, and policy profile to reproduce the same integrity, inclusion, anchor-sufficiency, current-record-selection, current-for-operational-use determination, stale or non-current classification, integrity and provenance policy result, and machine-actionable gating outcomes.

### BRIEF DESCRIPTION OF THE DRAWINGS

The accompanying drawings, which are incorporated herein and constitute a part of this specification, illustrate certain exemplary embodiments of the present invention and, together with the description, serve to explain the principles, structure, operation, and implementation of the invention. It is to be understood that the drawings are provided for purposes of illustration and explanation and are not necessarily drawn to scale. Like reference numerals generally refer to like elements throughout the drawings, although the same reference numerals may, where appropriate, refer to analogous elements, modules, data structures, or process stages in different figures.

FIG. 1 is a high-level block diagram of an Ecoh-Ledger system including a bundle builder, a hash-and-sign module, a hardware security module, a content-address publication module, a transparency log, an anchoring module, a verification service, one or more client devices, one or more developer or operator environments, one or more regulator or auditor terminals, and a communications network.

FIG. 2 is a schematic representation of an exemplary canonical bundle for a constant record, the bundle including a constant identifier field, an exact-value field, one or more display-value fields, an uncertainty field, a unit field, an exact-derivation field, a display-derivation field, a framework identifier field, a timestamp field, a schema-version field, a supersedes field, a proof-metadata field, a key-identifier field, optional construction or version metadata, and a canonical serialized byte stream.

FIG. 3 is a schematic and flow representation of bundle construction and secure signing, including an air-gapped or controlled workstation, a canonical bundle, a one-way transfer medium, a hardware security module, an internal hash engine, a digest output, a signature engine, a private key store, a signature output, a key identifier, an independent verification workstation, and a publication handoff.

FIG. 4 is a schematic representation of content-address publication and retrieval, including a signed bundle package or canonical bundle, an IPFS or other content-address publication node, a resulting content identifier, a primary gateway, one or more mirrored gateways, one or more alternative archives or repositories, a retrieval requester, and a returned content object.

FIG. 5 is a schematic representation of an append-only transparency log and associated Merkle structure, including sequential publication entries, a leaf-hash layer, intermediate hash nodes, a Merkle root, a consistency proof path, an inclusion proof path, a root-anchor queue, and a cached root store.

FIG. 6 is a schematic representation of blockchain or public-ledger anchoring, including an anchor scheduler, a current Merkle root, one or more anchor publication paths to respective public ledgers, an on-chain or public anchor record, a confirmation or status tracker, and a timestamp witness.

FIG. 7 is a flow diagram of an online verification process, including a verify request, a content identifier input, a content retrieval operation, a hash recomputation operation, a signature verification operation, an inclusion-proof verification operation, an anchor verification operation, a policy engine, a response object, a status field, and a diagnostic payload.

FIG. 8 is a schematic and flow representation of an offline verification process, including an offline verifier, a cached root repository, a local bundle repository, a local hash engine, a signature verifier, a proof verifier, an air-gapped host or restricted environment, a result output, and a latency monitor.

FIG. 9 is a flow diagram of batch verification, including a batch verify request, a list of content identifiers, a shared proof engine, a deduplication module, a proof cache, parallel verification workers, per-record results, and a batch summary.

FIG. 10 is a schematic representation of versioning and supersedence, including an earlier bundle, a later bundle, a supersedes link, a retained historical entry, a version graph, calibration or anchor metadata, a validity window, and a latest-version resolver.

FIG. 11 is a schematic representation of a multi-constant registry embodiment, including an E_coh bundle, one or more additional constant bundles, a constant-set bundle, a shared transparency log, a shared verification interface, and a cross-reference index.

FIG. 12 is a schematic representation of a device, regulatory, and deployment ecosystem, including a hardware root of trust or secure enclave, a boot loader or device controller, a calibration module, a CI/CD or software verification environment, a manufacturer or operator system, a regulator or auditor portal, a proof package, and a supply-chain or compliance record.

### DETAILED DESCRIPTION OF THE INVENTION

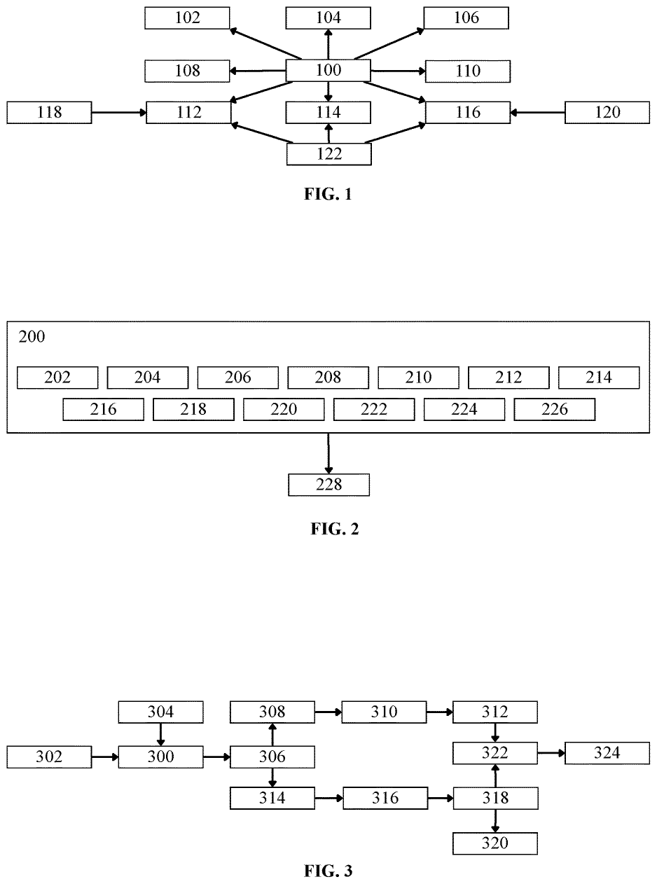

Reference will now be made in detail to exemplary embodiments of the invention illustrated in FIGS. 1-12, in which like reference numerals designate like or corresponding elements where appropriate. The embodiments described herein are illustrative and explanatory rather than limiting, and the invention may be embodied in many different forms, architectures, process flows, software implementations, hardware arrangements, network topologies, cryptographic configurations, storage arrangements, and deployment environments. The present disclosure is drafted to provide a complete and robust description of the invention for examination, prosecution, implementation, enforcement, and later claim support, and accordingly the specific examples, modules, fields, operations, and embodiments described herein are to be understood as non-limiting examples unless expressly stated otherwise. No additional internal headings are used in this Detailed Description, and the opening language of each paragraph is intended to make clear the subject matter being discussed so that the narrative remains easy to follow while preserving the continuous format required for the present application.

As used herein, a “constant record” refers to a machine-readable representation of one or more scientific, technical, computational, physical, calibration, or parameter values together with metadata sufficient to describe, authenticate, publish, retrieve, version, supersede, and verify the represented value or values. A constant record may include, by way of example and not limitation, an identifier, an exact-value expression, one or more display values, one or more units, uncertainty information, derivation metadata, framework metadata, timestamp information, schema-version information, key metadata, proof metadata, supersedence metadata, anchoring metadata, retrieval metadata, and verification metadata. A constant record may correspond to a single constant, multiple constants, a constant set, a parameter set, a calibration package, a technical dependency package, or a related data artifact whose provenance and integrity are to be preserved across time, users, systems, and jurisdictions. The term is intended to be interpreted broadly so as to encompass both presently preferred constant-oriented embodiments and analogous embodiments in which the same provenance architecture is applied to other machine-verifiable technical values or value groupings.

As used herein, a “bundle” refers to a canonical machine-readable data object representing a constant record. A bundle may be implemented in JSON, CBOR, Protocol Buffers, XML, ASN.1, a binary canonical form, or any other suitable serialized or serializable representation, provided that the selected representation supports deterministic canonicalization sufficient to permit reproducible hashing and signature verification across independent implementations. In preferred embodiments, the bundle is canonicalized prior to hashing and signing so that the same semantic input yields the same canonical byte sequence. In some embodiments, the bundle is the primary published object. In some embodiments, the bundle is encapsulated inside a signed bundle package. In some embodiments, both the canonical bundle and the signed bundle package are published and cross-referenced. The invention is not limited to any one serialization format so long as canonicalization is sufficiently defined to ensure deterministic byte formation for the object to be authenticated.

As used herein, an “exact-value field” refers to a field carrying a symbolic, algebraic, canonical, exact, or semantically invariant representation of a value, and a “display-value field” refers to a field carrying a calibrated, converted, rounded, formatted, or presentation-oriented representation of the corresponding value. As used herein, “presentation-layer metadata” includes one or more of a unit identifier, a display-precision identifier, a rounding-policy identifier, a formatting-policy identifier, a calibration-policy identifier, an external anchor-version identifier, a schema-version identifier, and a validity-window identifier, where such metadata affects a displayed representation of a constant without changing an exact-value representation of the constant. As used herein, a “first deterministic digest” refers to a digest computed over a canonicalized subset of a canonical bundle comprising at least a constant identifier field and an exact-value field and, in some embodiments, also an exact-derivation field. As used herein, a “second deterministic digest” refers to a digest computed over a canonicalized subset of the canonical bundle comprising at least a display-value field and one or more associated presentation-layer metadata fields. As used herein, “phi” refers to the golden ratio, i.e., phi=(1+sqrt(5))/2, and “phi\hat{ }(−5)” refers to phi raised to the power of negative five. In the preferred E_coh embodiment disclosed herein, the exact-value field may store the expression E_coh=phi\hat{ }(−5) or a semantically equivalent canonical expression, while the display-value field may store one or more values represented in electronvolts, joules, frequency units, thermal units, normalized units, or other suitable engineering, scientific, computational, or regulatory forms. The exact-value field and the display-value field are distinct in meaning and function. The exact-value field preferably preserves an invariant semantic representation of the constant, while the display-value field may be changed, refined, reformatted, or augmented in later bundle versions without implying that the exact semantic content of the constant has changed. In certain preferred embodiments, a verifier or policy engine is configured to distinguish a later record that preserves an unchanged exact-value field and changes only one or more display-value fields or associated presentation-layer metadata from a later record that changes the semantic content represented by the exact-value field. In some embodiments, that distinction is implemented mechanically by computing the first deterministic digest and the second deterministic digest for an earlier record and a later record. A later record may be classified as a “superseded-display record” when the first deterministic digest matches that of a referenced earlier record and the second deterministic digest differs, and may be classified as a “semantic-change record” when the first deterministic digest differs from that of the referenced earlier record. This distinction is important because many practical update events concern representation, display precision, formatting, declared calibration basis, declared anchor basis, or other presentation-layer conventions rather than substantive semantic revision, and the invention provides a mechanism for preserving that distinction in a cryptographically anchored, append-only publication history.

As used herein, a “publication record” refers to data recorded in an append-only registry or transparency log to preserve publication history, integrity, chronology, and verifiability. A publication record may include, by way of example, a content identifier, a digest, a signature, timestamp information, an index, a key identifier, a supersedence pointer, one or more proof references, one or more anchor references, or any combination thereof. The publication record may be identical to the bundle, may reference a separately published bundle, may encapsulate a signed bundle package, or may store selected metadata derived therefrom. The term “signed bundle package” refers to a package containing a canonical bundle together with a signature and, optionally, supporting verification materials such as a digest, a public-key identifier, a certificate chain, a signing-epoch identifier, an inclusion proof, an anchor reference, a schema identifier, or similar supporting metadata. The term “content identifier” or “CID” refers to a content-derived locator or identifier by which a published object may be retrieved based on the content of the object rather than solely on a mutable storage location. The term “inclusion proof” refers to data sufficient to demonstrate that a publication record is included in a committed log state, the term “consistency proof” refers to data sufficient to demonstrate that a later log state is an append-only extension of an earlier log state, and the term “anchor record” refers to a public, externally verifiable commitment, timestamped publication, blockchain entry, ledger entry, or analogous immutable witness of a transparency-log state or related publication state.

As used herein, the terms “supersedes,” “supersedence,” “version lineage,” and related expressions refer to relationships between records in which a later record references an earlier record for the purpose of indicating that the later record updates, refines, replaces, extends, corrects, or is to be preferred over the earlier record for one or more designated purposes, while the earlier record remains preserved and independently verifiable. Supersedence does not require deletion, alteration, or destruction of the earlier record. Instead, supersedence preferably preserves history while allowing later policy engines, verifiers, devices, or software systems to prefer the later record under selected operational or audit rules. This feature is particularly useful where an exact-value field remains semantically unchanged while a display-value field, declared unit convention, declared precision, declared framework version, declared anchor version, declared signing epoch, or other ancillary metadata is updated.

With reference to FIG. 1, an Ecoh-Ledger system 100 is shown as including a bundle builder 102, a hash-and-sign module 104, a hardware security module 106, a content-address publication module 108, a transparency log 110, an anchoring module 112, a verification service 114, one or more client devices 116, one or more developer or operator environments 118, one or more regulator or auditor terminals 120, and a communications network 122. Bundle builder 102 is configured to receive, construct, normalize, or otherwise generate the data used to form a constant record. Hash-and-sign module 104 is configured to compute or obtain a cryptographic digest and to coordinate generation of a digital signature over a designated payload. Hardware security module 106 is configured to protect private key material and to perform secure signing operations. Content-address publication module 108 is configured to publish the bundle, a signed bundle package, or both, to one or more content-addressable systems. Transparency log 110 is configured to record publication records in append-only form. Anchoring module 112 is configured to publish log-state commitments or equivalent commitments to one or more public immutable systems. Verification service 114 is configured to verify integrity, authenticity, inclusion, anchoring, and policy status. Client devices 116 may include computers, servers, embedded systems, instruments, devices, controllers, or software consumers. Developer or operator environments 118 may include build systems, simulation systems, administrative consoles, publication consoles, deployment systems, or maintenance systems. Regulator or auditor terminals 120 may include compliance systems, audit workstations, review portals, or supervisory interfaces. Communications network 122 may include local, wide-area, public, private, wireless, wired, virtual, or hybrid networking paths.

With further reference to FIG. 1, Ecoh-Ledger system 100 may be implemented in centralized, distributed, federated, mirrored, containerized, virtualized, partially offline, hybrid-cloud, or fully local forms. In some embodiments, bundle builder 102 and hash-and-sign module 104 are operated by the same entity, whereas transparency log 110 and anchoring module 112 are operated by the same or a different entity. In some embodiments, verification service 114 is provided by the publication operator. In some embodiments, verification service 114 is independently implemented by a third party using only public information or publicly retrievable information. In some embodiments, one or more client devices 116 store cached records, cached roots, public keys, or local bundles for offline use. In some embodiments, the stored offline materials further include policy-profile metadata, key-epoch metadata, and one or more committed-log-state identifiers sufficient to permit later policy-qualified verification without live network access. In some embodiments, one or more regulator or auditor terminals 120 are configured to monitor transparency-log changes, compare anchor states, or independently reproduce verification outcomes. The architecture is intentionally modular, and any one or more of modules 102-120 may be combined, subdivided, mirrored, distributed, virtualized, containerized, or implemented in hardware, software, firmware, or combinations thereof without departing from the invention.

With still further reference to FIG. 1, bundle builder 102 preferably performs deterministic canonicalization because reproducible hashing, signing, content-address generation, and cross-environment verification depend upon stable byte-level formation of the object to be authenticated. In some embodiments, bundle builder 102 receives explicit values for all required fields. In some embodiments, bundle builder 102 derives selected values from a policy template, schema profile, or framework profile. In some embodiments, bundle builder 102 validates field completeness, semantic admissibility, formatting, timestamp syntax, schema conformance, and policy conformance before permitting the bundle to proceed to hash-and-sign module 104. In some embodiments, bundle builder 102 also records internal construction metadata, operator metadata, or ceremony metadata, although such additional metadata may remain out of the public-facing canonical bundle if desired. These variations allow the invention to support high-assurance publication workflows without requiring a single rigid publication path.

With reference to FIG. 2, a canonical bundle 200 is shown as including a constant identifier field 202, an exact-value field 204, a display-value field 206, an uncertainty field 208, a unit field 210, an exact-derivation field 212, a display-derivation field 214, a framework identifier field 216, a timestamp field 218, a schema-version field 220, a supersedes field 222, a proof-metadata field 224, a key-identifier field 226, optional construction or version metadata 230, and a canonical serialized byte stream 228. Constant identifier field 202 identifies the constant or constant set represented by bundle 200. Exact-value field 204 stores a symbolic, canonical, or semantically invariant representation of the value and, in the preferred E_coh embodiment, stores E_coh=phi\hat{ }(−5) or an equivalent canonical expression. Display-value field 206 stores one or more calibrated, converted, rounded, or presentation-oriented forms corresponding to the same underlying exact value, such as electronvolt, joule, frequency, thermal, or other engineering or scientific display forms. Uncertainty field 208 stores uncertainty information or, in some embodiments, a statement that the exact-value field is exact and has zero uncertainty. Unit field 210 stores one or more units associated with one or more display representations. Exact-derivation field 212 stores metadata describing the semantic, symbolic, or derivational basis of the exact-value representation. Display-derivation field 214 stores metadata describing the basis of a displayed representation, such as a calibration convention, anchor convention, or conversion rule. Framework identifier field 216 stores a scientific, technical, or computational framework identifier and, in some embodiments, stores a Recognition-Physics identifier, a Recognition Science identifier, or a Recognition-Science-derived framework-profile identifier such that a verifier can determine the governing exact-value semantics, derivation references, proof references, or display-calibration conventions applicable to the bundle. Timestamp field 218 stores explicit time metadata, preferably in standardized UTC format. Schema-version field 220 stores the applicable structural version of the bundle format. Supersedes field 222 links a later bundle to one or more earlier bundles or publication records. Proof-metadata field 224 stores one or more theorem references, proof references, proof hashes, proof-system identifiers, or certificate identifiers. Key-identifier field 226 stores metadata identifying the verification key, signing epoch, or key family associated with the signing event. Canonical serialized byte stream 228 represents the deterministically serialized form of bundle 200 and is preferably the byte representation used for hashing, signing, or both.

With further reference to FIG. 2, the relationship between exact-value field 204 and display-value field 206 may take many forms. In some embodiments, display-value field 206 stores a single preferred presentation value. In some embodiments, display-value field 206 stores multiple permitted presentation values under different declared unit conventions. In some embodiments, display-value field 206 stores multiple presentation values under different calibration-policy identifiers or anchor-version identifiers. In some embodiments, uncertainty field 208 applies only to the display value while the exact-value field remains semantically exact. In some embodiments, exact-derivation field 212 and display-derivation field 214 jointly identify that the exact semantic expression is invariant while the display layer is dependent on declared conventions. This field architecture is advantageous because it permits a later bundle to change displayed precision, displayed units, or declared display basis without incorrectly implying that the exact scientific or semantic content of the constant itself has changed.

With still further reference to FIG. 2, canonical serialized byte stream 228 is preferably formed under a deterministic canonicalization policy that governs at least field ordering, field naming, encoding, whitespace treatment, numeric formatting, omitted-field handling, escaping conventions, date representation, and nested object ordering. In one non-limiting example, the canonicalization policy orders object keys lexicographically, encodes the serialization as UTF-8, emits numeric values in a normalized decimal representation, omits insignificant whitespace, and excludes non-deterministic fields unless such fields are expressly supplied as inputs to bundle construction. In some embodiments, the canonicalization policy is fixed by schema version. In some embodiments, the canonicalization policy is fixed by a framework profile or publication-policy profile. In some embodiments, canonical serialized byte stream 228 is itself stored or retrievable as part of the bundle, while in other embodiments it is reconstructed deterministically from the canonical field set. The invention does not require any specific canonicalization algorithm so long as identical semantic input yields identical canonical bytes under the applicable policy, thereby enabling consistent digest generation and signature validation across different verifier implementations and reducing false verification failures caused by serialization differences across heterogeneous verifier environments. This deterministic canonicalization is also advantageous because it constrains equivocation opportunities that could otherwise arise if semantically identical records were serialized differently across publisher and verifier implementations, thereby improving reproducibility in online verification, offline verification, batch verification, and policy-based status classification workflows, and further enabling independently implemented verifiers presented with the same semantic input, schema-version-specific canonicalization profile, and policy profile to reproduce the same canonical byte stream, digest input, downstream policy-qualified verification outcome, and integrity and provenance policy result.

With reference to FIG. 3, a secure construction and signing workflow 300 is shown as including an air-gapped or controlled workstation 302, a canonical bundle 304, a one-way transfer medium 306, a hardware security module 308, an internal hash engine 310, a digest output 312, a signature engine 314, a private key store 316, a signature output 318, a key identifier 320, an independent verification workstation 322, and a publication handoff 324. Air-gapped or controlled workstation 302 is configured to construct or receive canonical bundle 304 in deterministic form. One-way transfer medium 306 may include a QR-code path, guarded removable media path, one-direction serial transfer path, or other controlled transfer mechanism suitable for moving the bundle or designated payload to hardware security module 308. Hardware security module 308 performs secure cryptographic operations using internal hash engine 310 and signature engine 314 while protecting private key material in private key store 316. Digest output 312 may be computed inside hardware security module 308 or may correspond to a digest supplied thereto, depending on implementation. Signature output 318 carries the resulting signature. Key identifier 320 may identify the key epoch, key family, or active signing key used. Independent verification workstation 322 may validate consistency among canonical bundle 304, digest output 312, signature output 318, and key identifier 320 before publication handoff 324 occurs.

With further reference to FIG. 3, the signing workflow 300 may be implemented as a formal signing ceremony. In one representative embodiment, canonical bundle 304 is first validated for schema conformance, required-field presence, determinism, and policy admissibility on air-gapped or controlled workstation 302. The approved bundle is then transferred by one-way transfer medium 306 to hardware security module 308. Internal hash engine 310 computes or confirms the cryptographic digest represented by digest output 312. Signature engine 314 then signs the relevant payload using private key material maintained in private key store 316. Signature output 318 and key identifier 320 are returned for independent checking by independent verification workstation 322, which may be operated by a different operator, a different organizational role, or a different physical system for segregation of duties. In one non-limiting implementation, publication handoff 324 occurs only after independent verification workstation 322 confirms schema conformance, digest agreement, signature validity, and key-identifier consistency for the approved payload. After successful validation, publication handoff 324 releases the signed materials for publication. This process supports strong assurance that the published record was deterministically formed, properly signed, and independently checked before external publication, such that independently implemented verification systems presented with the same canonical bundle, digest output, signature output, key identifier, and schema-version-specific canonicalization profile reproduce the same signature-verification outcome, the same publication-readiness determination, and the same integrity and provenance policy result. With still further reference to FIG. 3, private key store 316 may be implemented in a FIPS-rated HSM, secure enclave, trusted platform, or other protected hardware boundary. In some embodiments, private key material never leaves hardware security module 308 in plaintext. In some embodiments, multiple secure hardware modules exist in geographically distinct secure locations for continuity, key-escrow avoidance, disaster recovery, or threshold approval workflows. In some embodiments, key identifier 320 is used by downstream verifiers to determine which public key, key family, or key epoch applies to a given signature. In some embodiments, the publication system enforces key-rotation policies, deprecation policies, or sunset policies while preserving the validity of historical signatures associated with prior key epochs, such that independently implemented verifiers presented with the same key-epoch metadata, public-key material, signature, and policy profile reproduce the same historical-validity determination, the same current-for-operational-use determination, and the same integrity and provenance policy result. In some embodiments, a publication record or proof package further stores a key-epoch identifier, a signing-epoch identifier, a key-status indicator, or a deprecation indicator usable by a verifier in determining whether a record remains acceptable for operational use notwithstanding continued cryptographic verifiability of a historical signature. The invention therefore supports both long-term record verification and operational key hygiene.

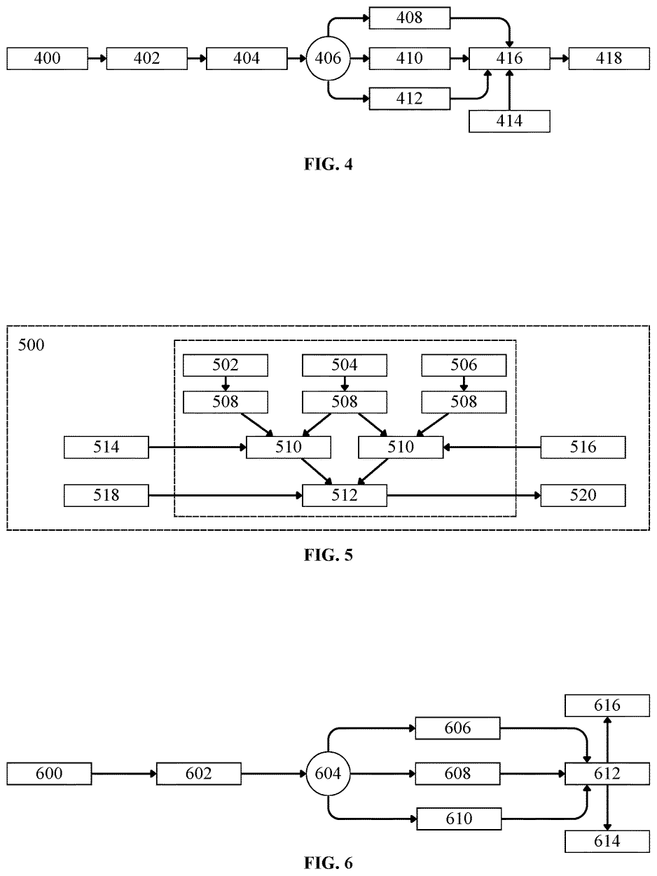

With reference to FIG. 4, a content-address publication and retrieval arrangement 400 is shown as including a signed bundle package 402, an IPFS or other content-address publication node 404, a content identifier 406, a primary gateway 408, an academic mirror 410, a CDN-backed gateway 412, an alternative archive 414, a retrieval requester 416, and a returned content object 418. Signed bundle package 402 may alternatively be canonical bundle 304 itself, depending on embodiment. Publication node 404 is configured to accept the object to be published and to return content identifier 406 derived from the content of the published object. Primary gateway 408, academic mirror 410, CDN-backed gateway 412, and alternative archive 414 represent different retrieval paths or persistence paths by which the same published content may later be accessed. Retrieval requester 416 may be a verification service, device, software application, build pipeline, regulator, auditor, manufacturer, or other consumer. Returned content object 418 is the object retrieved by requester 416 in response to content identifier 406 or a linked retrieval request.

With further reference to FIG. 4, the invention advantageously decouples retrievability from trust. A retriever may obtain returned content object 418 from any of gateways 408-412 or archive 414, but that retrieval event alone does not establish authenticity, recency, inclusion in the append-only log, or policy-acceptability. Instead, authenticity is determined by recomputing the digest of returned content object 418, checking the signature associated with the object, verifying the corresponding publication record in the transparency log, and checking any required anchor or policy conditions. In one non-limiting implementation, returned content object 418 is accepted only when a recomputed digest exactly matches a stored digest or a digest recovered from the signed payload and when the signature verifies under authorized public-key material associated with the identified signing epoch. Thus, the system is robust to stale mirrors, hostile mirrors, renamed copies, relocated copies, or multiple geographically distributed retrieval sources. In some embodiments, content-address publication module 108 may deliberately publish to multiple storage substrates so that persistence, redundancy, and censorship resistance are improved without weakening provenance verification.

With still further reference to FIG. 4, the object associated with content identifier 406 may be the canonical bundle, the signed bundle package, a manifest pointing to multiple bundle-related objects, or a package containing the bundle plus one or more proofs or references. In some embodiments, a verifier compares multiple retrieved copies corresponding to a common content identifier and treats byte-identical agreement among the multiple retrieved copies as corroborative of retrieval integrity while continuing to rely on signature verification, log inclusion, and anchor-state verification for authenticity and policy acceptance, such that independently implemented verifiers presented with the same retrieved copies, public-key material, proof material, and policy profile reproduce the same retrieval-integrity determination, the same acceptance or rejection outcome, and the same integrity and provenance policy result. In some embodiments, the transparency log records content identifier 406 directly. In some embodiments, the transparency log records a digest of the object associated with content identifier 406 in addition to the CID itself. In some embodiments, the log entry references one public object and one private or semi-private supporting object. These variants preserve flexibility in claim scope while maintaining the core concept of content-addressable publication bound into an append-only, cryptographically verifiable provenance framework. In some embodiments, the package containing the bundle plus one or more proofs or references further includes a committed-log-state identifier, a key-epoch identifier, or an external anchor reference so that a verifier can reconstruct a policy evaluation without relying on a live network query at the time of use. In some embodiments, the package further includes a digest of the published object sufficient to support later proof-package reconstruction even if the object is retrieved from a different storage endpoint than the original publication endpoint. In one non-limiting implementation, the verifier rejects the package when the CID-resolved object, the signed payload, and the stored digest fail to correspond to the same byte sequence under the declared canonicalization policy, and accepts the package for further policy evaluation only when the CID-resolved object, the signed payload, the stored digest, and the declared canonicalization policy are sufficient for independently implemented verifiers to reproduce the same byte-sequence correspondence determination and the same integrity and provenance policy result. With reference to FIG. 5, an append-only transparency-log arrangement 500 is shown as including a first publication entry 502, a second publication entry 504, a third publication entry 506, a leaf-hash layer 508, intermediate hash nodes 510, a Merkle root 512, a consistency proof path 514, an inclusion proof path 516, a root-anchor queue 518, and a cached root store 520. Publication entries 502, 504, and 506 may store, by way of example, an index, a content identifier, signature information, timestamp information, and optional digest, key, proof, or supersedence metadata. In FIG. 5, reference numeral 508 denotes multiple instances of leaf-hash nodes, and reference numeral 510 denotes multiple instances of intermediate hash nodes. Leaf-hash layer 508 is constructed by deterministically hashing the entries or designated entry payloads. Intermediate hash nodes 510 are generated by deterministic combination of child nodes according to the selected authenticated-tree scheme. Merkle root 512 represents the committed state of the log at a given size, epoch, or publication state. Inclusion proof path 516 permits a verifier to establish that a given record is included in the committed state represented by Merkle root 512. Consistency proof path 514 permits a verifier to establish that a later committed state is an append-only extension of an earlier committed state. In some embodiments, a verifier uses a previously trusted root from cached root store 520 together with consistency proof path 514 to validate that a newer committed state extends, rather than rewrites, the previously trusted state before accepting later proof material or later policy outcomes. Root-anchor queue 518 stores pending or scheduled commitments for external anchoring. Cached root store 520 stores previously trusted or observed roots for later verification, monitoring, or offline use.

With further reference to FIG. 5, transparency-log arrangement 500 may be implemented as a public log, permissioned log, mirrored log, federated log, or operator-controlled log with public monitoring interfaces. In some embodiments, publication entries 502-506 are serially indexed. In some embodiments, entries carry publication epochs, signing epochs, record classes, or framework-version tags. In some embodiments, root-anchor queue 518 is populated on a timed schedule, while in others it is populated based on thresholds such as number of new entries, type of entry, sensitivity level, or operator policy. In some embodiments, cached root store 520 is maintained by the operator, while in other embodiments it is independently maintained by third-party monitors, regulators, or device fleets. The transparency-log concept is therefore broader than any particular implementation while still preserving its essential append-only and proof-generating characteristics.

With still further reference to FIG. 5, a representative leaf value may be generated from a deterministic combination of index, CID, signature, and timestamp, or from a deterministic combination of digest, signature, CID, and metadata, or from another equivalent log-entry encoding. In one non-limiting example, the leaf value is generated from a length-delimited concatenation of an index, a content identifier, a digital signature, and timestamp information, such that independently implemented verifiers can reproduce the same leaf input bytes from the same publication record. In one further non-limiting example, the index is encoded as a fixed-width unsigned integer, the CID, signature, timestamp information, and optional metadata fields are UTF-8 encoded or binary encoded under a declared schema, each field is preceded by a deterministic length value, and the resulting byte sequence is hashed with SHA-256 to generate the leaf value. In some embodiments, the deterministic log-entry encoding further includes a key identifier, a signing-epoch identifier, a supersedence pointer, or a committed-log-state identifier so that the same publication record supports later audit reproduction, proof-package generation, and current-version resolution. The invention does not require a single mandatory leaf formula so long as the chosen formula is deterministic and preserves the verifiable link between publication-record content and committed tree state. Similarly, the invention does not require a particular branching factor, a particular concatenation format, or a particular Merkle-tree library. The essential point is that the tree structure yields compact commitments and efficiently checkable proof material sufficient to demonstrate inclusion and append-only extension. In some embodiments, the deterministic log-entry encoding and tree-construction rules are further selected such that independently implemented verifiers presented with the same publication records reproduce the same leaf values, intermediate hash nodes, Merkle root, inclusion-proof outcomes, consistency-proof outcomes, and downstream integrity and provenance policy results when the same policy profile is applied.

With reference to FIG. 6, an anchoring arrangement 600 is shown as including an anchor scheduler 602, a current Merkle root 604, an Ethereum anchor path 606, a Bitcoin anchor path 608, a Solana anchor path 610, an on-chain anchor record 612, a confirmation or status tracker 614, and a public timestamp witness 616. Anchor scheduler 602 controls when anchoring occurs, whether on a fixed schedule, policy schedule, threshold basis, event basis, or demand basis. In some embodiments, anchor scheduler 602 enforces a declared anchoring cadence or a validity-window policy used by downstream verifiers when determining whether a record remains policy-acceptable for operational use. In one non-limiting implementation, the anchoring cadence is every 10 minutes, hourly, daily, or weekly, and confirmation or status tracker 614 applies a confirmation-depth condition selected from 1-64 confirmations or a chain-specific finality condition before the corresponding anchor is treated as confirmed for operational use. Current Merkle root 604 is the transparency-log commitment selected for external publication. Ethereum anchor path 606, Bitcoin anchor path 608, and Solana anchor path 610 are representative public-ledger embodiments, but other external immutable publication systems may be substituted. On-chain anchor record 612 stores, references, or reflects the commitment associated with current Merkle root 604. Confirmation or status tracker 614 monitors publication success, confirmation depth, finality, or other anchor-state conditions. Public timestamp witness 616 represents the externally observable timing evidence associated with the anchor record.

With further reference to FIG. 6, anchoring arrangement 600 provides several technical advantages. First, it supplies external evidence that the log had a particular committed state at or before a particular public time. Second, it reduces reliance on operator assertions regarding publication chronology. Third, it increases resistance to later log rewriting or selective suppression because the anchored root can be compared against the subsequently presented log. Fourth, it allows independently operated monitors or verifiers to use different public systems as corroborating witnesses. In some embodiments, multiple anchors for the same root are published on multiple systems. In some embodiments, different anchor systems serve different latency, cost, persistence, or trust needs. In some embodiments, an anchor may encode the root directly, while in others the anchor encodes or references a derivative commitment. In some embodiments, a verifier evaluates a plurality of external anchor records corresponding to a common committed log state and applies a confirmation-depth rule, a finality rule, a quorum rule, a precedence rule, or a chain-specific trust weighting rule when determining whether the committed log state is acceptable for operational use. In one non-limiting implementation, the verifier selects as controlling evidence the earliest sufficiently confirmed anchor, the most recent sufficiently confirmed anchor, or a quorum-supported anchor according to a declared policy profile. In some embodiments, the declared policy profile further specifies a deterministic anchor-resolution ordering under which conflicting external-anchor evidence is resolved by evaluating confirmation depth, finality status, quorum satisfaction, and declared precedence so that independent implementations presented with the same anchor-state data reach the same current-for-operational-use determination and the same integrity and provenance policy result. These variations do not change the fundamental role of anchoring as externalized, timestamped evidence of registry state.

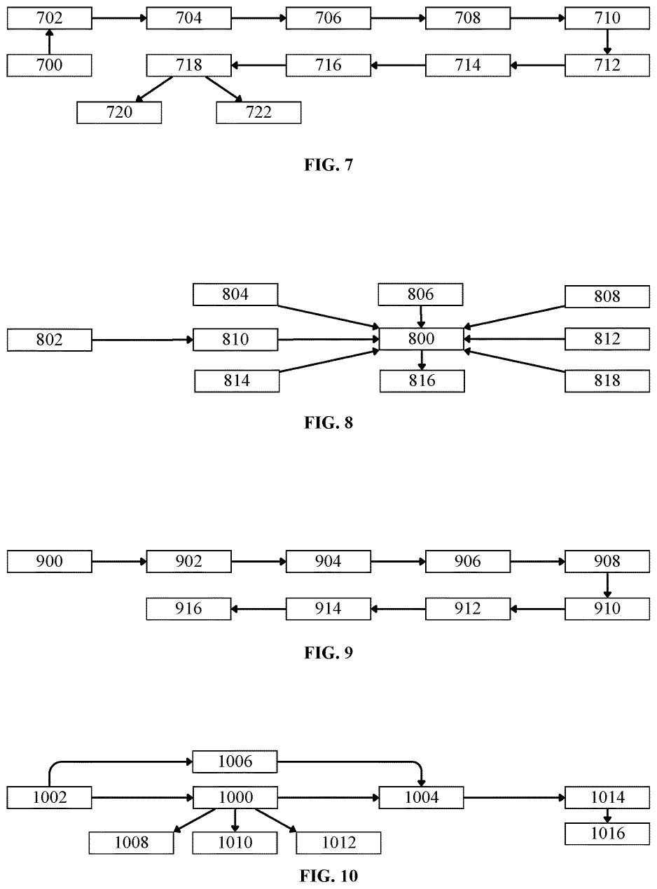

With reference to FIG. 7, an online verification flow 700 is shown as including a verify request 702, a content identifier input 704, a content retrieval operation 706, a hash recomputation operation 708, a signature verification operation 710, an inclusion-proof verification operation 712, an anchor verification operation 714, a policy engine 716, a response object 718, a status field 720, and a diagnostic payload 722. Verify request 702 may identify a specific CID, specific historical record, current-version request, or policy-qualified request. Content identifier input 704 supplies the locator or identifier to be resolved. Content retrieval operation 706 obtains the relevant bundle or signed package. Hash recomputation operation 708 computes a digest from the retrieved payload. Signature verification operation 710 checks that the signature corresponds to the digest or signed payload under an authorized public key. Inclusion-proof verification operation 712 checks log inclusion. Anchor verification operation 714 checks the correspondence between the relevant log commitment and a trusted external anchor state. Policy engine 716 applies any additional acceptance logic, such as freshness, key status, revocation status, current-version preference, supersedence status, validity-window status, framework-policy status, or schema-policy status. In preferred embodiments, policy engine 716 is configured to emit a structured machine-actionable verification result that is directly consumable by an automated device boot path, build gate, calibration controller, deployment controller, or compliance workflow, such that an unverified, stale, superseded, policy-rejected, or semantically changed record can be rejected without human interpretation before the dependent technical operation is allowed to proceed. Response object 718 is then returned and includes status field 720 and diagnostic payload 722.

With further reference to FIG. 7, response object 718 may be structured for machine consumption, human consumption, or both. In some embodiments, status field 720 takes values such as valid, invalid, unknown, stale, superseded, pending, deprecated, policy-rejected, superseded-display, semantic-change, or non-current. In some embodiments, the superseded-display status indicates that a later record preserves the same exact-value field while changing only one or more display-value fields or associated presentation-layer metadata selected from a unit identifier, a display-precision identifier, a rounding-policy identifier, a formatting-policy identifier, a calibration-policy identifier, an external anchor-version identifier, a schema-version identifier, and a validity-window identifier. In some embodiments, policy engine 716 determines whether the later record is superseded-display or semantic-change by computing a first deterministic digest over a canonicalized subset comprising at least the constant identifier field and the exact-value field and a second deterministic digest over a canonicalized subset comprising at least the display-value field and at least one associated presentation-layer metadata field for an earlier record and a later record, classifying the later record as superseded-display when the first deterministic digest matches between the earlier record and the later record and the second deterministic digest differs, and classifying the later record as semantic-change when the first deterministic digest differs. In one non-limiting example, an earlier record may store an exact-value field expressing E_coh=phi\hat{ }(−5) together with a first electronvolt display representation, and a later record may preserve the same exact-value field while updating only the electronvolt display representation to greater precision or updating only declared display-precision metadata, declared calibration-policy metadata, declared external anchor-version metadata, or declared validity-window metadata, in which case policy engine 716 classifies the later record as superseded-display rather than semantic-change. In some embodiments, policy engine 716 applies one or more objective acceptance rules in addition to cryptographic verification, including a stale threshold based on elapsed time since a most recent confirmed external anchor record, a minimum confirmation-depth threshold for an external anchor record, a key-epoch allowlist condition requiring that a key-epoch identifier correspond to an authorized public key for a publication epoch, a validity-window rule requiring that a current time fall within a declared validity window before the record is treated as valid for operational use, a non-revoked-key-status rule, and a precedence rule for resolving conflicting external-anchor evidence, wherein a policy profile may be expressed as a machine-readable object comprising stale_threshold_hours, minimum_confirmation_depth, validity_window_duration, authorized_key_epoch_allowlist, and resolver_order, and wherein one non-limiting example policy profile sets stale_threshold_hours=24, minimum_confirmation_depth=12, validity_window_duration_days=30, authorized_key_epoch_allowlist={“2025-A”}, and resolver_order=[supersedence, validity_window, anchor_sufficiency, key_authorization, publication_recency]. In some embodiments, policy-rejected indicates that cryptographic integrity and log inclusion are satisfied but at least one objective acceptance rule fails, non-current indicates that a record remains authentic but is not selected by a latest-version resolver operating under the objective acceptance rules, and unknown indicates that at least one required verification input is unavailable under a selected verification mode. In one non-limiting implementation, the stale threshold is 6 hours, 24 hours, 3 days, or 30 days after a most recent confirmed external anchor record, the minimum confirmation-depth threshold is 1-64 confirmations depending on chain type and policy profile, the validity window is 1 hour, 24 hours, 7 days, 30 days, or open-ended until supersedence, and a bounded-latency acceptance path for online or offline operational use completes within 1-100 milliseconds when a committed log state, relevant proof material, and authorized public-key material are locally available. In some embodiments, diagnostic payload 722 identifies which verification stage failed or succeeded, which key material was applied, which anchor state was checked, which version chain was traversed, which supersedence relationship was encountered, which policy rule was triggered, or which local or remote data source was used. In some embodiments, diagnostic payload 722 further identifies whether rejection resulted from stale status, non-current status, insufficient confirmation depth, key-status failure, validity-window failure, policy-profile mismatch, or conflicting-anchor resolution. In some embodiments, verification service 114 returns binary success or failure results only. In other embodiments, it returns layered results suitable for pipelines, dashboards, audits, and debugging. This makes the invention useful not only for public lookup but also for automated technical workflows in which different failure causes should be treated differently.

With still further reference to FIG. 7, online verification flow 700 may also resolve current-version state. In one embodiment, a requester supplies content identifier input 704 for a specific historical record and receives a verdict solely on that historical record. In another embodiment, the requester supplies a constant identifier and asks for the latest policy-qualified record. In that case, policy engine 716 may use transparency-log information and supersedence relationships to resolve the latest non-superseded, non-revoked, currently acceptable record before returning response object 718. In some embodiments, where multiple candidate records remain after supersedence filtering, policy engine 716 applies a resolver rule that prefers a candidate satisfying a validity-window rule, an external-anchor confirmation-depth rule, a key-epoch authorization rule, a non-revoked key-status rule, a chain-specific anchor-trust rule, or a more recent publication timestamp. In one non-limiting implementation, policy engine 716 applies the resolver rule in a deterministic order of supersedence status, validity-window satisfaction, anchor sufficiency, key authorization, and publication recency. This allows the invention to support both historical authenticity verification and operational current-state resolution, and further allows independent implementations presented with the same candidate record set, committed log state, proof material, public-key material, and policy profile to reach the same current-record selection result, the same current-for-operational-use determination, and the same integrity and provenance policy result.

With reference to FIG. 8, an offline verification arrangement 800 is shown as including an offline verifier 802, a cached root repository 804, a local bundle repository 806, a local hash engine 808, a signature verifier 810, a proof verifier 812, an air-gapped host 814, a result output 816, and a latency monitor 818. Offline verifier 802 is configured to verify a record without requiring live communication with a network service at the time of verification. Cached root repository 804 stores one or more previously trusted roots or commitments. Local bundle repository 806 stores previously retrieved or locally supplied bundles or signed packages. Local hash engine 808 recomputes digests from those local objects. Signature verifier 810 checks the corresponding signatures using locally available public-key material. Proof verifier 812 checks inclusion or related proof materials against a cached root and, in some embodiments, further checks a consistency proof showing that a later committed log state is an append-only extension of a previously cached committed log state. Air-gapped host 814 represents a secure, disconnected, or restricted-comms environment in which the verification occurs. Result output 816 presents the verification result to a person, machine, process, boot path, or compliance workflow. Latency monitor 818 may track verification speed where bounded-time verification is desirable.

With further reference to FIG. 8, offline verification arrangement 800 is particularly advantageous in settings where network access is impossible, undesirable, prohibited, expensive, intermittent, or operationally risky. By caching one or more trusted roots in cached root repository 804 and maintaining local bundle repository 806, the verifying system can still establish integrity, authenticity, inclusion status, and, where applicable, append-only extension of a later committed log state relative to a previously trusted committed log state without needing to contact a remote service at the moment of use. In some embodiments, offline verifier 802 also uses locally cached public-key material, locally cached proof material, or both. In some embodiments, the locally cached proof material includes an inclusion proof, a consistency proof, a committed-log-state identifier, an external anchor reference, key-epoch metadata, policy-profile metadata, and a digest of the published object sufficient to reproduce an acceptance decision offline, such that independently implemented offline verifiers presented with the same locally cached proof material, public-key material, and policy profile reproduce the same inclusion-proof outcome, consistency-proof outcome, anchor-sufficiency determination, current-for-operational-use determination, the same acceptance or rejection result, the same stale, non-current, superseded-display, or semantic-change classification, the same integrity and provenance policy result, and the same machine-actionable gating outcome. In some embodiments, offline verifier 802 is embedded in a device, controller, instrument, or boot path. In some embodiments, offline verifier 802 is implemented as a command-line tool, local library, or runtime module used by a simulation environment or CI/CD system. In some embodiments, the system later re-synchronizes anchor or root data when connectivity is restored. In some embodiments, offline verifier 802 applies the same objective acceptance rules and deterministic resolver ordering used in online verification such that the same locally available committed log state, proof material, public-key material, and policy profile produce the same inclusion-proof outcome, consistency-proof outcome, anchor-sufficiency determination, current-for-operational-use determination, the same acceptance or rejection result, the same stale, non-current, superseded-display, or semantic-change classification, the same integrity and provenance policy result, and the same machine-actionable gating outcome across independent implementations. These variations allow the invention to function across both highly connected and highly isolated operational environments.

With reference to FIG. 9, a batch verification arrangement 900 is shown as including a batch verify request 902, a content identifier list 904, a shared proof engine 906, a deduplication module 908, a proof cache 910, parallel verification workers 912, per-record results 914, and a batch summary 916. Batch verify request 902 initiates validation of multiple records. Content identifier list 904 identifies the requested records. Shared proof engine 906 allows common proof operations or proof-generation steps to be reused where multiple records share a common log state or proof context. Deduplication module 908 reduces redundant retrieval, hashing, or checking operations. Proof cache 910 stores reusable intermediate materials or prior verification artifacts. Parallel verification workers 912 allow concurrent checking of multiple requested records. Per-record results 914 capture the individual results, while batch summary 916 captures aggregate results, error counts, policy status, or similar summary information.

With further reference to FIG. 9, batch verification arrangement 900 is useful where the provenance of numerous constants or numerous versions must be checked together. By reusing shared proof materials, including in some embodiments inclusion-proof materials, consistency-proof materials, or both, and by avoiding redundant retrieval or digest computation where possible, the invention can reduce verification latency, reduce bandwidth usage, reduce computational duplication, and improve deployment efficiency. In some embodiments, batch summary 916 is used for release gating in CI/CD systems. In some embodiments, batch summary 916 additionally identifies whether one or more records failed because of stale status, non-current status, key-status failure, validity-window failure, or insufficient anchor confidence, thereby allowing different automated remediation paths to be invoked for different failure classes and permitting independently implemented batch verifiers presented with the same content identifier set, proof material, public-key material, and policy profile to reproduce the same failure-class attribution. In some embodiments, batch summary 916 further reports, for each verified record or for an aggregate verification set, a count of valid records, invalid records, stale records, non-current records, policy-rejected records, and records lacking sufficient anchor confidence, such that independently implemented batch verifiers presented with the same content identifier set, proof material, public-key material, and policy profile reproduce the same aggregate status counts and batch-summary determination. In some embodiments, it is used for compliance packages, supply-chain checkpoints, or fleet certification events. In some embodiments, per-record results 914 are archived for audit purposes. Thus, the invention supports not only one-record-at-a-time verification but also scalable provenance management for large technical ecosystems, with batch outcomes remaining reproducible across independent implementations when the same content identifier set, proof material, public-key material, and policy profile are evaluated, including reproduction of the same failure-class attribution, aggregate status counts, and batch-summary determination.

With reference to FIG. 10, a versioning and supersedence arrangement 1000 is shown as including an earlier bundle 1002, a later bundle 1004, a supersedes link 1006, a retained historical entry 1008, a version graph 1010, calibration or anchor metadata 1012, a validity window 1014, and a latest-version resolver 1016. Earlier bundle 1002 remains preserved after publication of later bundle 1004. Supersedes link 1006 expresses that later bundle 1004 updates, refines, replaces, or is preferred over earlier bundle 1002 for one or more designated purposes. Retained historical entry 1008 indicates that the earlier record remains in the append-only history and remains independently verifiable. Version graph 1010 may represent linear or branched version lineage. Calibration or anchor metadata 1012 may record why the later bundle differs from the earlier bundle, such as a change in display precision, display format, calibration metadata, anchor-version metadata, key metadata, or schema metadata. In preferred embodiments, latest-version resolver 1016 is configured to compare a first deterministic digest computed over at least a constant identifier field and an exact-value field with a second deterministic digest computed over at least a display-value field and associated presentation-layer metadata, thereby mechanically distinguishing a display-only refinement from a semantic revision and allowing an automated verifier to preserve exact Recognition-Science semantics while still accepting authorized display-layer updates. Validity window 1014 may express a time range or policy range in which a particular record is preferred. Latest-version resolver 1016 may determine which record is current under a selected rule set.

With further reference to FIG. 10, this supersedence architecture provides a significant technical benefit because it avoids destructive overwrite while preserving operational usability. In the preferred E_coh embodiment, later bundle 1004 may preserve the exact-value expression E_coh=phi\hat{ }(−5) while refining only the display-value representation or associated presentation-layer metadata selected from a unit identifier, a display-precision identifier, a rounding-policy identifier, a formatting-policy identifier, a calibration-policy identifier, an external anchor-version identifier, a schema-version identifier, and a validity-window identifier. In some embodiments, latest-version resolver 1016 or an associated policy engine determines whether later bundle 1004 is a superseded-display record or a semantic-change record by computing a first deterministic digest over a canonicalized subset comprising at least the constant identifier field and the exact-value field and a second deterministic digest over a canonicalized subset comprising at least the display-value information and at least one associated presentation-layer metadata field for earlier bundle 1002 and later bundle 1004, by classifying later bundle 1004 as superseded-display when the first deterministic digest remains unchanged while the second deterministic digest changes, and by classifying later bundle 1004 as semantic-change when the first deterministic digest changes. Because retained historical entry 1008 remains present and independently verifiable, the system supports regulatory review, reproducibility analysis, forensic comparison, and historical technical traceability. At the same time, latest-version resolver 1016 allows real-world systems to determine which record should presently be used in an operational or publication context. In some embodiments, latest-version resolver 1016 designates an authentic but not presently selected record as non-current where the record remains verifiable in the append-only history but is disfavored under a resolver rule based on validity-window status, external-anchor confirmation depth, key-epoch authorization, or recency. Accordingly, the invention preserves history without sacrificing current-state utility.

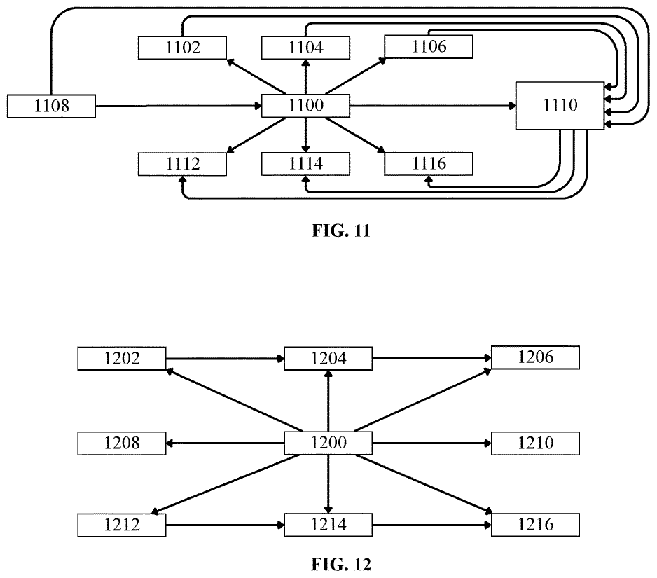

With reference to FIG. 11, a multi-constant registry arrangement 1100 is shown as including an E_coh bundle 1102, an X_opt bundle 1104, an R_RP bundle 1106, an eta_RP bundle 1108, a constant-set bundle 1110, a shared transparency log 1112, a shared verification interface 1114, and a cross-reference index 1116. E_coh bundle 1102 stores the principal constant record emphasized in this disclosure. X_opt bundle 1104, R_RP bundle 1106, and eta_RP bundle 1108 are representative additional constant records. Constant-set bundle 1110 references multiple individual bundles so that a coordinated versioned set may be published and verified as a group. Shared transparency log 1112 records the publication history of the multiple bundles. Shared verification interface 1114 allows a verifier to request validation of an individual constant bundle or a set bundle. Cross-reference index 1116 may store mapping, lookup, grouping, or dependency information among the records.

With further reference to FIG. 11, multi-constant registry arrangement 1100 shows that the disclosed Ecoh-Ledger architecture is not limited to a single constant, even though E_coh is the primary present embodiment. In some implementations, a technical workflow may depend on a coordinated set of constants rather than a single constant. Constant-set bundle 1110 therefore allows a bundle to point to several individual bundles and thereby define a coherent set that can be versioned, signed, logged, anchored, and verified as a group. This supports software environments, hardware environments, and research environments in which multiple values must remain synchronized to a common framework version, publication epoch, or technical release, and in some embodiments allows independently implemented verifiers presented with the same constant-set bundle, referenced individual bundles, proof material, public-key material, and policy profile to reproduce the same set-level acceptance or rejection outcome and the same set-level integrity and provenance policy result.

With reference to FIG. 12, a deployment and compliance ecosystem 1200 is shown as including a hardware root of trust or secure enclave 1202, a boot loader or device controller 1204, a calibration module 1206, a CI/CD or software verification environment 1208, a manufacturer or operator system 1210, a regulator or auditor portal 1212, a proof package 1214, and a supply-chain or compliance record 1216. Hardware root of trust or secure enclave 1202 may store trusted public-key material, cached commitments, or verification policy data. Boot loader or device controller 1204 may require successful verification of a constant record before enabling one or more operational states. Calibration module 1206 may consume a verified constant record in order to generate, confirm, or authorize calibration settings. CI/CD or software verification environment 1208 may require successful record verification before permitting a build, simulation, deployment, or test to proceed. Manufacturer or operator system 1210 may include record verification in production, service, or maintenance workflows. Regulator or auditor portal 1212 may receive and inspect proof materials. Supply-chain or compliance record 1216 may preserve evidence that verification occurred at one or more checkpoints.

With further reference to FIG. 12, deployment and compliance ecosystem 1200 demonstrates that provenance verification is itself a technical dependency that can affect whether software runs, whether a device boots, whether calibration is accepted, whether a product is released, whether a regulatory record is complete, and whether a supply-chain checkpoint is passed. Thus, the invention is not merely a passive publication archive. Instead, it can be integrated into active technical control loops and operational gates. In some embodiments, failure of verification causes a build failure, calibration rejection, device lockout, warning issuance, audit exception, or maintenance hold. In some embodiments, an otherwise authentic record is still rejected for operational use when a policy-profile mismatch, key-status mismatch, validity-window failure, or insufficient external-anchor confidence condition is detected. In some embodiments, successful verification causes a signed attestation, audit log entry, checkpoint record, or state transition. In some embodiments, a workflow decision further depends on whether a verified record is current, historical, superseded, policy-rejected, or superseded-display. In one non-limiting implementation, the workflow decision is deterministic under a declared policy profile such that the same verified inputs produce the same allow, deny, hold, or warning outcome across independent implementations, wherein the verified inputs comprise at least a committed-log-state identifier, relevant proof material, public-key material, supersedence data, and a policy profile sufficient to reproduce the same current-for-operational-use determination, the same integrity and provenance policy result, and the same operational gating decision. This operational coupling between provenance status and technical action is one of the practical advantages of the disclosed architecture.

In the preferred embodiment, the invention is directed to the Recognition-Physics cohesion quantum E_coh. In such embodiment, the exact-value field stores the semantically invariant expression E_coh=phi\hat{ }(−5), and one or more display-value fields store one or more calibrated or presentation-oriented representations suitable for engineering, software, publication, or regulatory use. The invention advantageously separates the semantic exact-value representation from the displayed representation so that a later record may refine display precision, units, formatting, declared calibration basis, declared anchor basis, or other presentational metadata while maintaining the same exact-value content. In this way, the Ecoh-Ledger architecture preserves exact semantic continuity while permitting non-destructive, append-only refinement of displayed information. The verifier need not recompute the scientific derivation in order to validate provenance and integrity; rather, the verifier validates the published record, the cryptographic authenticity layer, the append-only inclusion state, and, where applicable, the anchor state and supersedence state.

In some embodiments, the bundle may include proof metadata identifying formal proof artifacts, theorem identifiers, proof-file identifiers, proof hashes, certificate identifiers, or related references corresponding to the exact-value relation, positivity, derivation from phi, deterministic bundle formation, deterministic hashing, sign-then-verify correctness, append-only behavior, inclusion-proof validity, consistency-proof validity, or other relevant properties. In some embodiments, those proof references are primarily for advanced users, auditors, or technical reviewers, while ordinary cryptographic verification proceeds without needing to execute a theorem prover. In some embodiments, the bundle may include multiple display-value fields corresponding to multiple accepted representations, multiple units, or multiple approved calibration conventions. In some embodiments, the exact-value field itself may be encoded symbolically, algebraically, by an expression tree, or by a functionally equivalent canonical representation. These variations are all contemplated.

In one representative publication example, a first bundle may store an exact-value field expressing E_coh=phi\hat{ }(−5), a display-value field expressing an electronvolt representation, an uncertainty statement corresponding to the exact-value field, framework metadata, timestamp metadata, schema metadata, proof metadata, and key metadata. That bundle may then be canonicalized, hashed, signed, published to content-addressable storage, inserted into the transparency log, and later externally anchored. In a second representative publication example, a later bundle may preserve the same exact-value field but update one or more display-value fields to greater precision or revised declared display metadata and may include a supersedes link pointing back to the earlier bundle. In a third representative publication example, a later bundle may preserve the same exact-value field and display-value field while updating only schema metadata, key-epoch metadata, or external anchor metadata, such that the later bundle functions as a schema update, key-rotation update, or anchor-metadata update without constituting a semantic revision of the constant. In another representative example, a build system or simulation environment may store a CID corresponding to a published E_coh record and may halt execution if verification fails. In another representative example, a hardware device may verify the relevant record before enabling a calibration or operating state. In another representative example, a regulator or auditor may receive proof package 1214 and use it to independently verify the provenance of the constant record used in a regulated device, process, or filing. In another representative example, the proof package identifies a committed-log-state identifier, a key epoch, an external anchor reference, a policy profile under which the record was accepted or rejected, and a digest of the published object or signed bundle package that was evaluated. In another representative example, a manufacturer may record verification status in supply-chain or compliance record 1216 at manufacture, shipment, installation, maintenance, and recertification checkpoints. In another representative example, the recorded verification status further identifies whether a record was accepted as current, accepted as historical, rejected as non-current, rejected as stale, or rejected under a policy-profile rule, thereby preserving audit-ready evidence of why a downstream operational decision was taken and permitting independently implemented reviewers presented with the same proof package, public-key material, anchor-state data, and policy profile to reproduce the same audit conclusion regarding current-for-operational-use status and integrity and provenance policy result. In another representative example, independent implementations evaluating the same proof package, policy profile, and published object reach the same inclusion-proof outcome, consistency-proof outcome, acceptance or rejection result, current-for-operational-use determination, integrity and provenance policy result, and machine-actionable gating outcome because canonicalization, digest computation, and resolver ordering are deterministic.

The order of operations described herein may vary among embodiments. Hashing may occur outside secure hardware or within secure hardware. Publication to content-address storage may occur before, after, or substantially contemporaneously with transparency-log insertion. Anchoring may occur immediately, periodically, in batches, or in response to one or more trigger conditions. Verification may be performed online, offline, continuously, periodically, synchronously, asynchronously, manually, automatically, or conditionally. A verifier may validate a specific historical record, a current record, a latest non-superseded record, a policy-qualified record, or a set record. These and similar ordering variations are contemplated and should not be taken as limiting unless expressly recited in the claims.

The modules and components disclosed herein may likewise be combined, subdivided, omitted, mirrored, distributed, replicated, virtualized, or replaced in particular embodiments. A single service may implement multiple disclosed functions, and multiple services may jointly implement a single disclosed function. A publication node may also act as a verification node. A log operator may also perform anchoring. A regulator portal may contain a local verifier. A hardware root of trust may incorporate a cached root store and public-key material. A bundle may be represented as a flat object, normalized multi-object structure, nested object structure, or functionally equivalent canonical representation. These and similar implementation variations are contemplated and are within the intended scope of the disclosure.

The terminology used herein is for the purpose of describing particular embodiments only and is not intended to be limiting. Unless the context clearly indicates otherwise, singular terms include plural implementations and plural terms include singular implementations. References to a “bundle,” “record,” “field,” “module,” “log,” “verifier,” “anchor,” “key,” “system,” or “device” include one or more such items. References to “blockchain” or “public ledger” include one or more public or externally verifiable immutable publication systems. References to “content-addressable storage” include one or more content-derived addressing systems or repositories. References to a “constant” include a single constant, a constant set, a parameter set, a calibration artifact, or analogous technical data where context permits. References to one component being “configured to” perform a function include direct implementation, indirect implementation, conditional implementation, software implementation, hardware implementation, firmware implementation, and combinations thereof.

Although particular embodiments of the present invention have been illustrated and described in detail, it will be apparent to those of ordinary skill in the art that modifications, substitutions, additions, omissions, combinations, and design variations may be made without departing from the spirit and scope of the invention. Accordingly, the foregoing description is to be regarded as illustrative rather than restrictive, and the scope of the invention is defined by the appended claims and equivalents thereof.

1. A computer-implemented method for registering and verifying a machine-readable constant record, the method comprising: constructing, by a bundle builder executing on one or more processors, a canonical bundle for the constant record, the canonical bundle comprising a constant identifier field, an exact-value field, a display-value field, timestamp information, and schema-version information; deterministically serializing the canonical bundle into a canonical byte stream under a schema-version-specific canonicalization profile such that identical input content yields an identical canonical byte stream across independent implementations and reduces false verification failures attributable to serialization differences; computing, by a cryptographic hashing operation executed by the one or more processors, a digest of the canonical byte stream or of a signed payload derived therefrom; generating, by a secure signing device comprising protected private-key material, a digital signature corresponding to the digest or the signed payload; publishing the canonical bundle, a signed bundle package containing the canonical bundle and the digital signature, or both, to a content-addressable storage system to obtain a content identifier derived from the published content; recording, in an append-only transparency log stored in computer memory, a publication record associated with the content identifier and comprising the digital signature and the timestamp information; generating, from the append-only transparency log, at least an inclusion proof for the publication record; and verifying the machine-readable constant record by retrieving the published content using the content identifier, recomputing the digest, verifying the digital signature, and verifying the inclusion proof against a committed log state, wherein verifying further comprises computing a first deterministic digest over a canonicalized subset comprising at least the constant identifier field and the exact-value field and computing a second deterministic digest over a canonicalized subset comprising at least the display-value field and at least one presentation-layer metadata field, classifying a later record that references an earlier record as superseded-display when the first deterministic digest matches between the later record and the earlier record and the second deterministic digest differs, and classifying the later record as semantic-change when the first deterministic digest differs, and outputting a structured machine-actionable verification status selected from valid, invalid, stale, superseded, superseded-display, semantic-change, unknown, non-current, and policy-rejected, wherein the structured machine-actionable verification status is usable to gate an automated boot, build, calibration, simulation, deployment, supply-chain, or compliance workflow, wherein the structured machine-actionable verification status is further produced under one or more objective acceptance rules comprising at least a stale-threshold rule, a minimum confirmation-depth rule, and a validity-window rule, and a deterministic resolver ordering that evaluates supersedence status, validity-window satisfaction, anchor sufficiency, key authorization, and publication recency such that independent implementations presented with the same committed log state, proof material, public-key material, and policy profile reproduce the same current-for-operational-use determination, the same stale, non-current, superseded-display, or semantic-change classification, the same integrity and provenance policy result, and the same machine-actionable gating outcome, wherein non-current indicates that a record is authentic but not selected by a latest-version resolver operating under one or more objective acceptance rules, wherein policy-rejected indicates that cryptographic integrity and log inclusion are satisfied but at least one objective acceptance rule fails, and wherein unknown indicates that at least one required verification input is unavailable under a selected verification mode.

2. The method of claim 1, wherein the exact-value field stores a semantically invariant symbolic representation of a constant and the display-value field stores a calibrated, converted, rounded, formatted, or presentation-oriented representation corresponding to the same constant.

3. The method of claim 2, wherein the constant is a Recognition-Physics cohesion quantum E_coh, the exact-value field stores E_coh=phi\hat{ }(−5) as a semantically invariant exact-value representation, and the display-value field stores an electronvolt representation of E_coh corresponding to the same exact-value representation.

4. The method of claim 1, wherein recording the publication record comprises recording, for the publication record, at least the content identifier, the digital signature, and the timestamp information as a log entry in a Merkle-based append-only transparency log, wherein the log entry is deterministically encoded so that independently implemented verifiers presented with the same publication record reproduce the same leaf input bytes, leaf value, inclusion-proof result, consistency-proof result, and committed log state under the same declared encoding.

5. The method of claim 4, further comprising generating a proof package comprising the inclusion proof, the consistency proof, a committed log state identifier, an external anchor reference, key-epoch metadata, policy-profile metadata, and a digest of the published object sufficient to permit offline verification, audit reproduction, or regulatory review independently of a particular storage location from which the published content is retrieved, wherein the proof package further comprises a schema identifier and a signing-epoch identifier, and wherein the proof package contains sufficient information for independent implementations applying the same policy profile to reproduce the same inclusion-proof outcome, consistency-proof outcome, anchor-sufficiency determination, current-for-operational-use determination, the same acceptance or rejection result, the same stale, non-current, superseded-display, or semantic-change classification, and the same integrity and provenance policy result for the machine-readable constant record.

6. The method of claim 4, further comprising publishing a commitment derived from the append-only transparency log to a plurality of externally verifiable immutable publication systems comprising at least a first public ledger and a second public ledger, recording a corresponding external anchor reference for the commitment, and using the corresponding external anchor reference as a public timestamp witness for later verification, wherein conflicting external-anchor evidence from the plurality of externally verifiable immutable publication systems is resolved according to a confirmation-depth rule, a finality rule, a quorum rule, or a precedence rule before the machine-readable constant record is treated as current for operational use, and wherein independent implementations presented with the same anchor-state data and the same declared policy profile reproduce the same current-for-operational-use determination and the same integrity and provenance policy result.

7. The method of claim 6, wherein verifying the machine-readable constant record further comprises verifying that the committed log state corresponds to an external anchor record published by the at least one public blockchain or other externally verifiable immutable publication system, classifying the machine-readable constant record as stale when a most recent confirmed external anchor record is older than a declared stale threshold selected from 6 hours, 24 hours, 3 days, and 30 days, requiring that the external anchor record satisfy at least a declared confirmation-depth condition selected from 1-64 confirmations, requiring that a key-epoch identifier correspond to an authorized public key for a publication epoch before the machine-readable constant record is treated as valid for operational use, and resolving conflicting external-anchor evidence according to a confirmation-depth rule, a finality rule, a quorum rule, or a precedence rule before the machine-readable constant record is treated as current for operational use.

8. The method of claim 1, further comprising storing, in the canonical bundle or publication record, supersedence metadata linking a later record to an earlier record and designating whether the later record is a display-only refinement, a key-rotation update, a schema update, an anchor-metadata update, or a semantic revision, wherein the designating comprises comparing the first deterministic digest and the second deterministic digest for the later record and the earlier record under the one or more objective acceptance rules, while leaving the earlier bundle or publication record preserved and independently verifiable in the append-only transparency log.

9. The method of claim 1, wherein verifying the machine-readable constant record is performed in an offline mode using a locally cached committed log state, locally available public-key material, a locally stored proof package comprising at least an inclusion proof, a committed-log-state identifier, an external anchor reference, key-epoch metadata, policy-profile metadata, and a digest of the published object, and a locally available bundle or signed bundle package, and optionally using a consistency proof to verify that a later committed log state is an append-only extension of a previously cached committed log state within a bounded verification latency selected from 1-100 milliseconds and suitable for release gating, device boot, or calibration control, wherein the offline mode applies the same objective acceptance rules and deterministic resolver ordering used in an online mode such that the same committed log state, proof package, public-key material, and policy profile produce the same inclusion-proof outcome, consistency-proof outcome, anchor-sufficiency determination, current-for-operational-use determination, the same acceptance or rejection result, the same stale, non-current, superseded-display, or semantic-change classification, the same integrity and provenance policy result, and the same machine-actionable gating outcome across independent implementations.

10. A system for maintaining an append-only, tamper-evident registry of machine-readable constant records, the system comprising: one or more processors; memory storing instructions that, when executed by the one or more processors, cause the system to perform operations comprising deterministic construction of a canonical bundle for a constant record, computation of a cryptographic digest for the canonical bundle or a signed payload derived therefrom, publication of the canonical bundle or a signed bundle package to a content-addressable storage system, insertion of a corresponding publication record into an append-only transparency log, generation of proof material for the publication record, and verification of the constant record using retrieved content, the cryptographic digest, a digital signature, and the proof material, wherein the verification comprises computation of a first deterministic digest over a canonicalized subset comprising at least a constant identifier field and an exact-value field and a second deterministic digest over a canonicalized subset comprising at least display-value information and at least one presentation-layer metadata field so as to distinguish a superseded-display record from a semantic-change record for a later record that references an earlier record, and wherein the verification produces a structured machine-actionable result usable to gate an automated boot path, build gate, calibration controller, deployment controller, supply-chain checkpoint, or compliance workflow, wherein the structured machine-actionable result is produced under one or more objective acceptance rules comprising at least a stale-threshold rule, a minimum confirmation-depth rule, and a validity-window rule, and a deterministic resolver ordering that evaluates supersedence status, validity-window satisfaction, anchor sufficiency, key authorization, and publication recency such that independent implementations presented with the same committed log state, proof material, public-key material, and policy profile reproduce the same current-for-operational-use determination, the same stale, non-current, superseded-display, or semantic-change classification, the same integrity and provenance policy result, and the same machine-actionable gating outcome, and wherein the deterministic construction is performed under a schema-version-specific canonicalization profile that causes semantically identical bundle content to produce identical canonical byte streams across independent implementations; a secure signing device configured to generate the digital signature using protected private-key material; and a verification interface configured to return a verification result for the constant record.

11. The system of claim 10, wherein deterministic construction of the canonical bundle comprises applying a canonicalization profile selected from RFC 8785 JSON Canonicalization Scheme, CBOR canonicalization, or deterministic Protocol Buffers serialization, the canonicalization profile ordering fields according to a canonical key ordering, encoding the canonical bundle in a deterministic byte representation, normalizing numeric formatting, omitting insignificant whitespace where applicable, and causing semantically identical bundle content to produce identical canonical byte streams across independent implementations, such that independently implemented verifiers reproduce the same digest input bytes for the same canonical bundle under the same schema-version-specific canonicalization profile.

12. The system of claim 10, wherein the append-only transparency log is a Merkle-based transparency log configured to generate a leaf value from a deterministic encoding comprising an index, a content identifier, a digital signature, timestamp information, and at least one of a key identifier, a signing-epoch identifier, a supersedence pointer, or a committed-log-state identifier, wherein the deterministic encoding is length-delimited and UTF-8 encoded and is hashed using SHA-256 or SHA-3 to produce the leaf value, to produce an inclusion proof for a publication record, to produce a consistency proof for append-only extension between log states, and to maintain a compact root commitment for a log state, such that independently implemented verifiers presented with the same publication record reproduce the same leaf value, inclusion-proof result, consistency-proof result, and compact root commitment under the same declared encoding.

13. The system of claim 12, further comprising an anchoring module configured to publish the compact root commitment, or a commitment derived therefrom, to one or more public blockchains or other externally verifiable immutable publication systems on an anchoring cadence selected from every 10 minutes, hourly, daily, and weekly, to track confirmation depth or finality for a corresponding external anchor record, to provide anchor-state data usable by a verifier in applying a stale-threshold policy, a confirmation-depth policy selected from 1-64 confirmations, or a validity-window policy, and to associate a committed-log-state identifier with a corresponding external anchor reference for later audit reproduction or offline verification, wherein the anchor-state data is further usable by the verifier in applying a confirmation-depth rule, a finality rule, a quorum rule, or a precedence rule before a record is treated as current for operational use and in reproducing the same integrity and provenance policy result across independent implementations applying the same declared policy profile.

14. The system of claim 10, wherein the verification interface is configured to return a structured response identifying whether the constant record is valid, invalid, unknown, stale, superseded, non-current, policy-rejected, superseded-display, or semantic-change, wherein superseded-display indicates that a later record preserves the same exact-value field while changing only display-value information or associated presentation-layer metadata selected from a unit identifier, a display-precision identifier, a rounding-policy identifier, a formatting-policy identifier, a calibration-policy identifier, an external anchor-version identifier, a schema-version identifier, and a validity-window identifier, wherein the verification interface determines whether the later record is superseded-display or semantic-change by comparing a first deterministic digest over a canonicalized subset comprising at least the constant identifier field and the exact-value field and a second deterministic digest over a canonicalized subset comprising at least the display-value information and at least one associated presentation-layer metadata field across an earlier record and a later record, wherein non-current indicates that a record is authentic but not selected by a latest-version resolver operating under one or more objective acceptance rules, wherein policy-rejected indicates that cryptographic integrity and log inclusion are satisfied but at least one objective acceptance rule fails, wherein unknown indicates that at least one required verification input is unavailable under a selected verification mode, and wherein the structured response further identifies at least one verification stage or policy condition that produced the structured response.

15. The system of claim 10, further comprising a batch verification engine configured to verify a plurality of content identifiers in a shared workflow using a shared proof engine, a deduplication module, a proof cache, parallel verification workers, and at least one reused inclusion-proof verification operation, reused consistency-proof verification operation, cached proof material, deduplicated retrieval operation, or shared committed-log-state verification operation, wherein batch summary output identifies whether one or more records failed because of stale status, non-current status, key-status failure, validity-window failure, or insufficient anchor confidence, and wherein the batch verification engine applies the one or more objective acceptance rules and deterministic resolver ordering to each content identifier such that independent implementations presented with the same committed log state, proof material, public-key material, and policy profile produce the same per-record outcomes, failure-class attributions, aggregate status counts, and batch-summary outcomes.

16. A non-transitory computer-readable medium storing instructions that, when executed by one or more processors, cause the one or more processors to: construct a canonical bundle for a machine-readable constant record; deterministically serialize the canonical bundle into a canonical byte stream under a schema-version-specific canonicalization profile such that semantically identical bundle content produces identical canonical byte streams across independent implementations; compute a cryptographic digest of the canonical byte stream or of a signed payload derived therefrom; verify a digital signature associated with the machine-readable constant record; verify, using proof material derived from an append-only transparency log, that a publication record associated with the machine-readable constant record is included in a committed log state; and output a structured machine-actionable verification result indicating whether the machine-readable constant record satisfies an integrity and provenance policy, wherein the one or more processors further compute a first deterministic digest over a canonicalized subset comprising at least a constant identifier field and an exact-value field and a second deterministic digest over a canonicalized subset comprising at least display-value information and at least one associated presentation-layer metadata field so as to distinguish a superseded-display record from a semantic-change record for a later record that references an earlier record, and wherein the structured machine-actionable verification result is usable to gate a device boot path, calibration workflow, simulation workflow, continuous integration workflow, supply-chain workflow, or regulatory compliance workflow, and wherein the structured machine-actionable verification result is produced under one or more objective acceptance rules comprising at least a stale-threshold rule, a minimum confirmation-depth rule, and a validity-window rule, and a deterministic resolver ordering that evaluates supersedence status, validity-window satisfaction, anchor sufficiency, key authorization, and publication recency such that independent implementations presented with the same committed log state, proof material, public-key material, and policy profile reproduce the same current-for-operational-use determination, the same stale, non-current, superseded-display, or semantic-change classification, the same integrity and provenance policy result, and the same machine-actionable gating outcome.

17. The non-transitory computer-readable medium of claim 16, wherein deterministically serializing the canonical bundle comprises applying a canonicalization profile selected from RFC 8785 JSON Canonicalization Scheme, CBOR canonicalization, or deterministic Protocol Buffers serialization, the canonicalization profile ordering fields according to a canonical key ordering, encoding the canonical bundle in a deterministic byte representation, normalizing numeric formatting, omitting insignificant whitespace where applicable, and causing semantically identical bundle content to produce identical canonical byte streams across independent implementations, and wherein the instructions further cause the one or more processors to compute (i) a first deterministic digest over a canonicalized subset comprising at least a constant identifier field and an exact-value field and (ii) a second deterministic digest over a canonicalized subset comprising at least display-value information and at least one associated presentation-layer metadata field selected from the group consisting of a unit identifier, a display-precision identifier, a rounding-policy identifier, a formatting-policy identifier, a calibration-policy identifier, an external anchor-version identifier, a schema-version identifier, and a validity-window identifier.

18. The non-transitory computer-readable medium of claim 16, wherein the instructions further cause the one or more processors to perform verification without live network access at a time of verification using a locally cached committed log state, locally cached public-key material, and a locally stored proof package comprising at least an inclusion proof, an external anchor reference, a committed-log-state identifier, key-epoch metadata, policy-profile metadata, and a digest of the published object, and optionally to verify, using a consistency proof, that a later committed log state is an append-only extension of a previously cached committed log state within a bounded verification latency selected from 1-100 milliseconds and suitable for release gating, device boot, or calibration control, wherein the verification without live network access applies the one or more objective acceptance rules and the deterministic resolver ordering such that the same committed log state, proof package, public-key material, and policy profile produce the same inclusion-proof outcome, consistency-proof outcome, anchor-sufficiency determination, current-for-operational-use determination, the same acceptance or rejection result, the same stale, non-current, superseded-display, or semantic-change classification, the same integrity and provenance policy result, and the same machine-actionable gating outcome across independent implementations.

19. The non-transitory computer-readable medium of claim 16, wherein the integrity and provenance policy requires successful verification of an external anchor record corresponding to the committed log state, classifies the machine-readable constant record as stale when a most recent confirmed external anchor record for the committed log state is older than a declared stale threshold selected from 6 hours, 24 hours, 3 days, and 30 days, requires that the external anchor record satisfy at least a declared confirmation-depth condition selected from 1-64 confirmations, requires that a key-epoch identifier associated with the machine-readable constant record correspond to an authorized public key for a publication epoch, and resolves conflicting external-anchor evidence according to a confirmation-depth rule, a finality rule, a quorum rule, or a precedence rule before the verification result indicates that the machine-readable constant record is valid, wherein the integrity and provenance policy further applies a deterministic resolver ordering that evaluates supersedence status, validity-window satisfaction, anchor sufficiency, key authorization, and publication recency before the verification result indicates that the machine-readable constant record is current for operational use.

20. The non-transitory computer-readable medium of claim 16, wherein the instructions are executable in a device boot path, calibration workflow, simulation workflow, continuous integration workflow, supply-chain workflow, or regulatory compliance workflow, and wherein the instructions further cause the one or more processors to resolve, using supersedence data and the deterministic digests, whether the machine-readable constant record is current, historical, superseded, superseded-display, or semantic-change by classifying a later record that references an earlier record as superseded-display when the first deterministic digest matches between the later record and the earlier record and the second deterministic digest differs, and as semantic-change when the first deterministic digest differs between the later record and the earlier record, and by applying the one or more objective acceptance rules and the deterministic resolver ordering to determine whether the machine-readable constant record is current for operational use, such that failure of verification, failure of an external-anchor confirmation-depth condition, classification of a record as stale, policy-rejected, or semantic-change, or selection of a non-current record prevents continuation of the workflow.
